(19) United States
(12) Patent Application Publication
(10) Pub. No.: US 2008/0021875 A1
(43) Pub. Date: Jan. 24, 2008

(54) Method and apparatus for performing a tone-based search

(76) Inventor: Kenneth Henderson, Folsom, CA (US)

Correspondence Address: INTUIT, INC.;c/o PARK, VAUGHAN & FLEMING LLP, 2820 FIFTH STREET, DAVIS, CA, 95618-7759, US

(21) Appl. No.: 11/489,315

(22) Filed: Jul. 19, 2006

(51) Int. Cl. G06F 17/30

(52) U.S. Cl. 707/3

(57) ABSTRACT

One embodiment of the present invention provides a system for performing a tone-based search. During operation, the system receives a search-request, which includes a search request-term. For each context-term in a pre-defined list of context-terms, the system, in response to receiving the search-term, searches a first set of documents for the context-term and the search-term, wherein each context-term is associated with a tone. Next, the system obtains a list of search results from the search, and for each search result in the list of search results, the system assigns a score. Then, for each search result in the list of search results, the system creates a link which points to the locations in a document of an occurrence of the search-term, and an occurrence of a context-term.

### BACKGROUND

### Related Art

The present invention relates to search engines. A search engine can be used to locate data in a computer system or a network of computer systems. Specifically, search engines have become important tools for navigating the World Wide Web (WWW).

Search engines usually rank the search results according to the popularity or relevance of the search results. However, it is usually difficult to use existing search engines to perform tone-based searches, i.e., specifically search for data that has a positive or negative connotation. Often, a user must perform several trial and error iterations to determine search terms that produce the desired results. This is not only a time-consuming process, but it can also be a very difficult process for a user who does not have a large vocabulary.

Furthermore, prior art search engines can produce misleading results. For example, a user searching for positive reviews of the iPod may search for the terms “love” and “ipod.” (Note that iPod may be a trademark of Apple Computer, Inc., which may be registered in the United States and/or other countries.) In response to this search request, a search engine may return a listing of several web-pages containing the words “love” and “ipod.” Some of the web-pages in the listing may include positive reviews of the iPod; however, many of the web-pages may not. The search results most likely contain these irrelevant web-pages because they include the terms “love” and “ipod” somewhere in their content, albeit in different contexts. For example, a web-page may include a blog that comprises multiple entries, wherein, in one entry, the blogger proclaims his love for another user, and in another unrelated entry, the blogger may mention in passing that he owns an iPod. Note that prior art search engines would include this web-page in the search results even though it is not what the user was searching for.

To summarize, due to the limitations of prior art search engines, users typically spend a substantial amount of time to determine search terms that produce the desired results, and/or spend a substantial amount of time to identify the relevant web-pages in the search results.

### SUMMARY

One embodiment of the present invention provides a system for performing a tone-based search. During operation, the system receives a search-request, which includes a search request-term. For each context-term in a pre-defined list of context-terms, the system, in response to receiving the search-term, searches a first set of documents for the context-term and the search-term, wherein each context-term is associated with a tone. Next, the system obtains a list of search results from the search, and for each search result in the list of search results, the system assigns a score. Then, for each search result in the list of search results, the system creates a link which points to the locations in a document of an occurrence of the search-term, and an occurrence of a context-term.

In a variation on this embodiment, the tone can be a positive tone, a negative tone, or a neutral tone.

In a variation on this embodiment, receiving the search-request involves the system receiving a tone-request, which is a request to search for terms that have a specific tone. Searching the first set of documents can involve the system searching for context-terms having the specific tone associated with the tone-request.

In a variation on this embodiment, the system calculates the score for a search result based on at least one of: a tone associated with each context-term; a frequency of each context-term; a relative location of each context-term with respect to the search-term; or a relative location of each context-term with respect to other context-terms in the pre-defined list of context-terms.

In a variation on this embodiment, the system, for each document in a second set of documents, searches for a set of context-terms from the pre-defined list of context-terms. The system subsequently determines a tone-rating for the document based on the context-terms identified in the document, wherein the tone-rating can be positive, negative, or neutral.

In a further variation, the first set of documents is a subset of the second set of documents.

In a further variation, the system receives a tone-request. In response to receiving the tone request, the system matches the tone-request to the tone-rating of each document in the second set of documents. If the tone-request matches the tone-rating of a document in the second set of documents, the system identifies the document as a member of the first set of documents.

In a variation on this embodiment, in response to activating a link for the search result, the system follows the link to a document which includes an occurrence of the search-term, and an occurrence of the context-term in the document. The system then presents the document to a user.

In a further variation, the tone-rating can be based on at least one of: a tone associated with each context-term in the document; a frequency of each context-term in the document; or a relative location of each context-term with respect to other context-terms in the document.

### BRIEF DESCRIPTION OF THE FIGURES

FIG. 1 illustrates a computing environment in accordance with an embodiment of the present invention.

FIG. 2 illustrates the result of performing a search in accordance with an embodiment of the present invention.

FIG. 3 illustrates a configuration-window in accordance with an embodiment of the present invention.

FIG. 4 presents a flowchart illustrating the process of performing a search in accordance with an embodiment of the present invention.

FIG. 5 presents a flowchart illustrating the process of presenting a document to a user in accordance with an embodiment of the present invention.

FIG. 6 presents a flowchart illustrating the process of preprocessing documents in accordance with an embodiment of the present invention.

FIG. 7 presents a flowchart illustrating the process of identifying documents to search in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. This includes, but is not limited to, magnetic and optical storage devices such as disk drives, magnetic tape, CDs (compact discs) and DVDs (digital versatile discs or digital video discs).

### Overview

One embodiment of the present invention includes a pluggable search-engine for finding data that has positive and/or negative connotations based on a score. The engine takes two sets of inputs: 1) Backend Input, which includes a reference to the searchable content, keywords, applicable categories, other (generic) reference criteria, and a score indicating the tone of the referenced content; and 2) Frontend Input, which includes a set of criteria for the tone-based search.

Note that an organization can integrate the pluggable search-engine into an existing application which can enable the existing application to include the functionality of the present invention. The pluggable search-engine is not limited to searching the Internet. Specifically, the pluggable search-engine can search any electronic source of data.

In one embodiment of the present invention, the pluggable search-engine enables users, and software developers to contribute their own named search criteria/script for public, or private use. For example, if a user creates a search-script that does a good job of finding the pros and cons of any organization that trades stocks, the user can publish the search script so that other users can use the search-script.

An embodiment of the present invention can include a web crawler that seeks out the tone as it crawls the WWW to facilitate the tone-based search. The web crawler can use a pattern matching technique, such as brute force text matching, fuzzy logic, or neural pattern matching to discover the overall tone of the content that the web crawler searches.

In one embodiment of the present invention, the tone is expressed as a number on a predetermined scale which facilitates ranked searches.

### Computing Environment

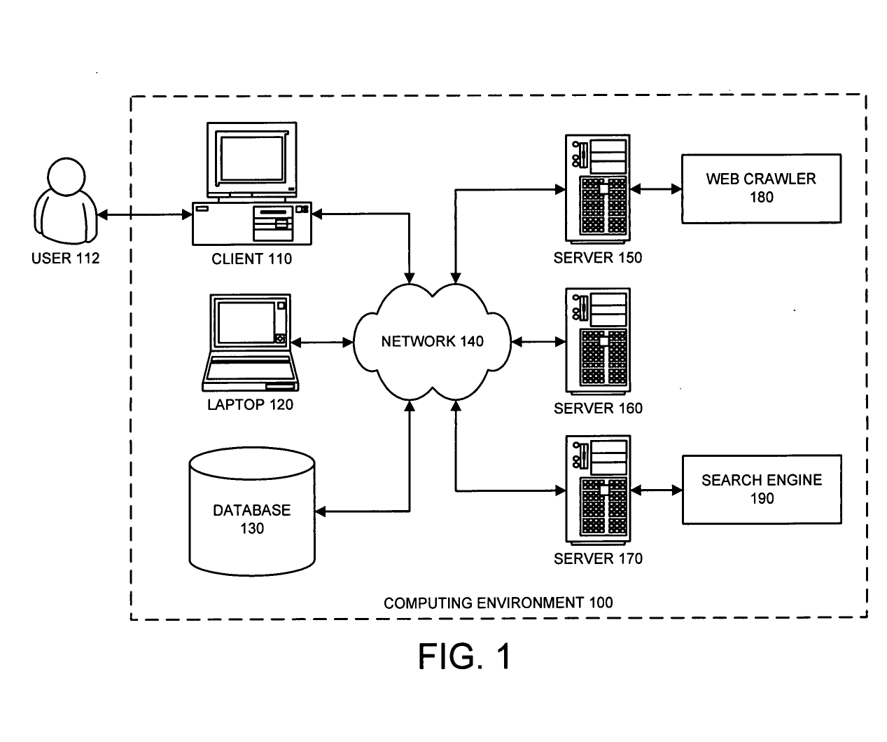

FIG. 1 illustrates a computing environment 100 in accordance with an embodiment of the present invention.

Computing environment 100 can generally include any type of computer system which can comprise a computer system based on a microprocessor, a mainframe computer, a digital signal processor, a portable computing device, a personal organizer, a device controller, and a computational engine within an appliance. Specifically, computing environment 100 can comprise client 110, laptop 120, database 130, network 140, server 150, server 160, server 170, web crawler 180, and search engine 190.

Client 110 and laptop 120 can generally include any node on a network including computational capability and including a mechanism for communicating across the network.

Database 130 can generally include any type of system for storing data in non-volatile storage. This includes, but is not limited to, systems based upon magnetic, optical, and magneto-optical storage devices, as well as storage devices based on flash memory and/or battery-backed up memory.

Network 140 can generally include any type of wired or wireless communication channel capable of coupling together computing nodes. This includes, but is not limited to, a local area network, a wide area network, or a combination of networks. In one embodiment of the present invention, network 140 comprises the Internet.

Servers 150, 160, and 170 can generally include any nodes on a computer network which comprises a mechanism for servicing requests from a client for computational and/or data storage resources.

Web crawler 180 can generally include any type of system for browsing a set of documents in a methodical and automated manner. Typically, web crawler 180 harvests information from the set of documents to facilitate search engine 190 to quickly index and search a set of documents. Note that web crawler 180 is not limited to browsing the Internet. Furthermore, note that server 150 hosts web crawler 180. In one embodiment of the present invention, web crawler 180 is a stand-alone system.

Search engine 190 can generally include any type of system for searching a set of documents for a search-term. Search engine 190 can search documents that a web crawler has previously identified and stored in database 130. Note that server 170 can host search engine 190. In one embodiment of the present invention, search engine 190 is a stand-alone system.

In one embodiment of the present invention, network 140 is the Internet. Web crawler 180 crawls network 140 with the purpose of sorting and indexing each web-page based on the web-page's tone, and storing copies of the web-pages on database 130. A user can then search these web-pages using search engine 190. For example, user 112 can search for reviews of the latest movie, or the newest movie star.

### Search Results

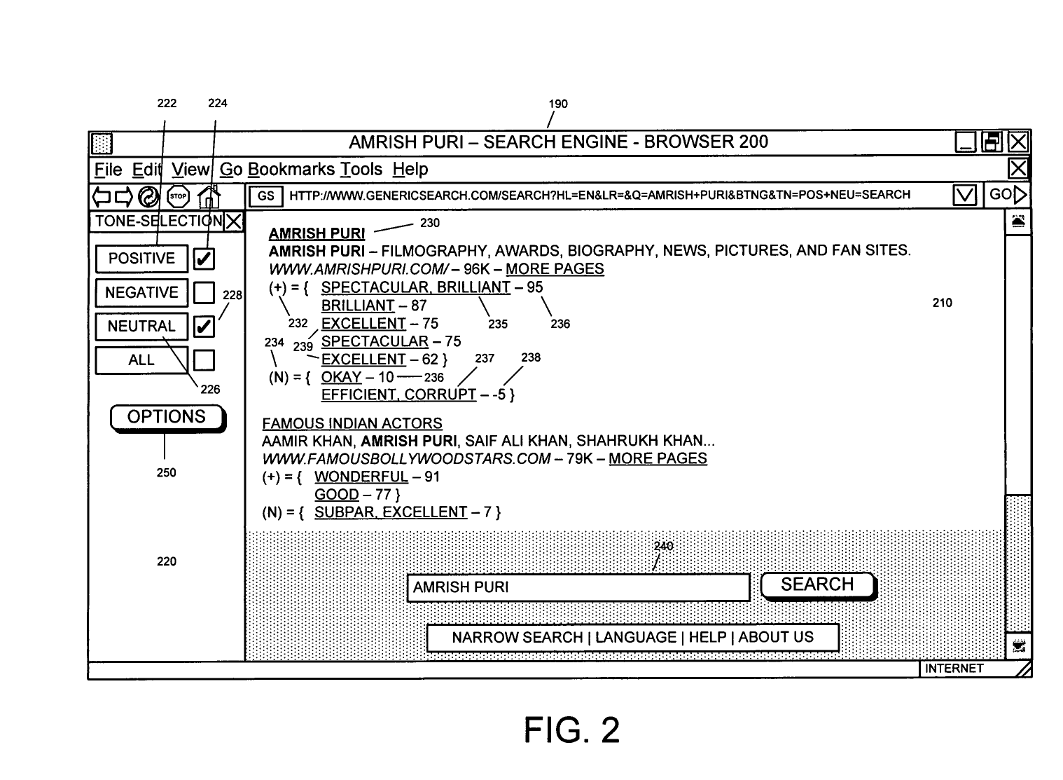

FIG. 2 illustrates the result of performing a search in accordance with an embodiment of the present invention.

In one embodiment of the present invention, user 112 uses search engine 190 (via browser 200) to search network 140 for information about “Amrish Puri.” To perform the search, user 112 enters “Amrish Puri” into search field 240. Next, user 112 selects positive tone 222 and neutral tone 226 by clicking checkboxes 224 and 228 in tone-selection panel 220 to indicate that user 112 desires search results that have a positive or neutral tone.

Panel 210 illustrates a possible result of user 112's search. The first result displayed, result 230, is titled “Amrish Puri.” Result 230 includes a set of positive context-term results 232, and a set of neutral context-term results 234. Each of the terms includes a score, such as score 236, which indicates whether the tone of the result is positive, negative, or neutral and by how much. For example, in one embodiment of the present invention, the closer the score of a result is to 100, the more positive the tone of the result.

In one embodiment of the present invention, the score can be based on the tone of a context-word, the location of the context-word in relation to the search-term, the location of the context-word in relation to other context-words, the frequency that the context-word appears in the document, and the ratio of the use of the context-word to the use of other context-words. Note that calculating the score for two instances of the same-context word can result in two different scores, such as with context-term result 239.

In one embodiment of the present invention, positive context-term results are the context-term results that have a score that is closer to 100 than to 0, such as context-term result 235 with score 236.

In one embodiment of the present invention, negative context-term results are the context-term results that have a score that is closer to −100 than to 0.

In one embodiment of the present invention, neutral context-term results are the context-term results that have a score that is closer to 0 than to either 100, or −100, such as context-term result 237 with score 238.

In one embodiment of the present invention, each context-term result is linked to the location in a document that search engine 190 found the context-term.

In one embodiment of the present invention, a context-term result can include multiple context-terms, such as context-term result 237.

### Search Engine Configuration

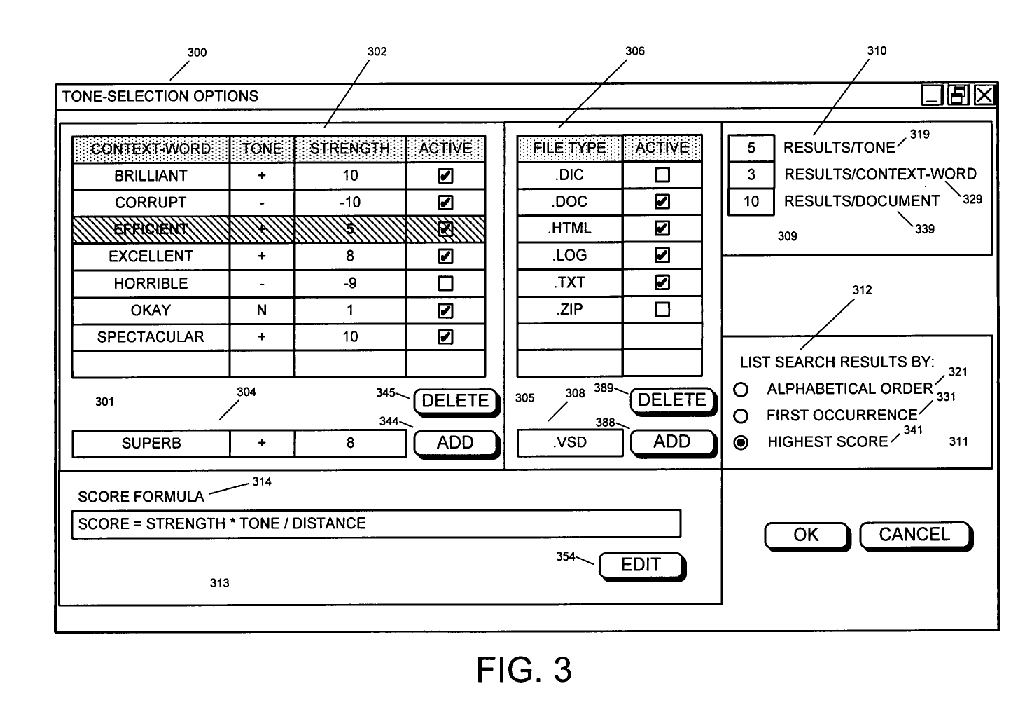

FIG. 3 illustrates a configuration-window in accordance with an embodiment of the present invention.

User 112 can navigate to a configuration-window, such as tone-selection options 300, by clicking on the options-button 250. Tone-selection options 300 includes context-word panel 301, file-type panel 305, result-count panel 309, result-order panel 311, and score panel 313.

In one embodiment of the present invention, context-word panel 301 includes context-word table 302, and context-word adder 304. In this embodiment, the context-words listed in context-word table 302 are the context-words that search engine 190 includes with a search-term while executing a search-request. Note that for each entry, context-word table 302 specifies a tone of the context-word, a strength of the context-word, and whether the context-word is currently included with each search. User 112 can add a new context-word to context-word table 302 via context-word adder 304. To do so, user 112 enters a context-word, a tone indicator, and a strength value into context-word adder 304. User 112 then clicks on the add-button 344 in context-word panel 301.

In one embodiment of the present invention, user 112 can remove the word “horrible” from the active list of searchable context-words. To do so, user 112 removes the checkmark from the active box associated with the word “horrible” in context-word table 302.

In one embodiment of the present invention, the symbol ‘+’ indicates a context-word with a positive tone, the symbol ‘−’ indicates a context-word with a negative tone and the letter ‘N’ indicates a context-word with a neutral tone.

In one embodiment of the present invention, user 112 deletes the context-word “efficient” from context-word table 302 by selecting the context-word and clicking on the delete-button 345 in context-word panel 301.

In one embodiment of the present invention, the strength field of context-word table 302 indicates how much a context-word should influence the score for a search-result. The more positive the tone of the context-word, the more positive the strength of the context-word, and the more negative the tone of the context-word, the more negative the strength of the context-word.

In one embodiment of the present invention, file-type panel 305 includes file-type table 306 and file-type adder 308. In this embodiment, file-type table 306 specifies the file types that search engine 190 searches when executing user 112's search request. User 112 can use file-type adder 308 to add a new file type. To do so, user 112 enters a file type into file-type adder 308, and then user 112 clicks on the add-button 388 in file-type panel 305.

In one embodiment of the present invention, user 112 can remove file types “.DIC,” and “.ZIP” from the active list of searchable file types. To do so, user 112 removes the check mark from the active box associated with the file types “.DIC,” and “.ZIP” in file-type table 306.

In one embodiment of the present invention, user 112 can delete a file type from file-type table 306. To do so, user 112 selects a file type and clicks the delete-button 389 in file-type panel 306.

In one embodiment of the present invention, user 112 indicates in result-count panel 309 the maximum results/tone, results/context-word, and results/document that search engine 190 can present to user 112. In this embodiment, user 112 can indicate that there is no maximum for each of the fields in result-count panel 309.

In one embodiment of the present invention, user 112 indicates in result-order panel 312 how search engine 190 is to order search results from user 112's search requests. In this embodiment, search engine 190 can order the results in alphabetical order 321, by order of first occurrence 331 in a search-result document, by highest score 341, or by any other ordering method known to those familiar in the art.

In one embodiment of the present invention, score panel 313 includes score formula 314, which indicates the formula that search engine 190 uses to score each search result that search engine 190 presents to user 112. In this embodiment, score formula 314 can be based on the tone of a context-word, the location of the context-word in relation to the search-term, the location of the context-word in relation to other context-words, the frequency that the context-word appears in the document, the ratio of use of the context-word to the use of other context-words, or any other scoring method known to those familiar in the art.

In one embodiment of the present invention, user 112 can specify score formula 314. To do so, user 112 clicks the edit-button 354, and then enters a score formula into score formula 314.

### Performing a Search

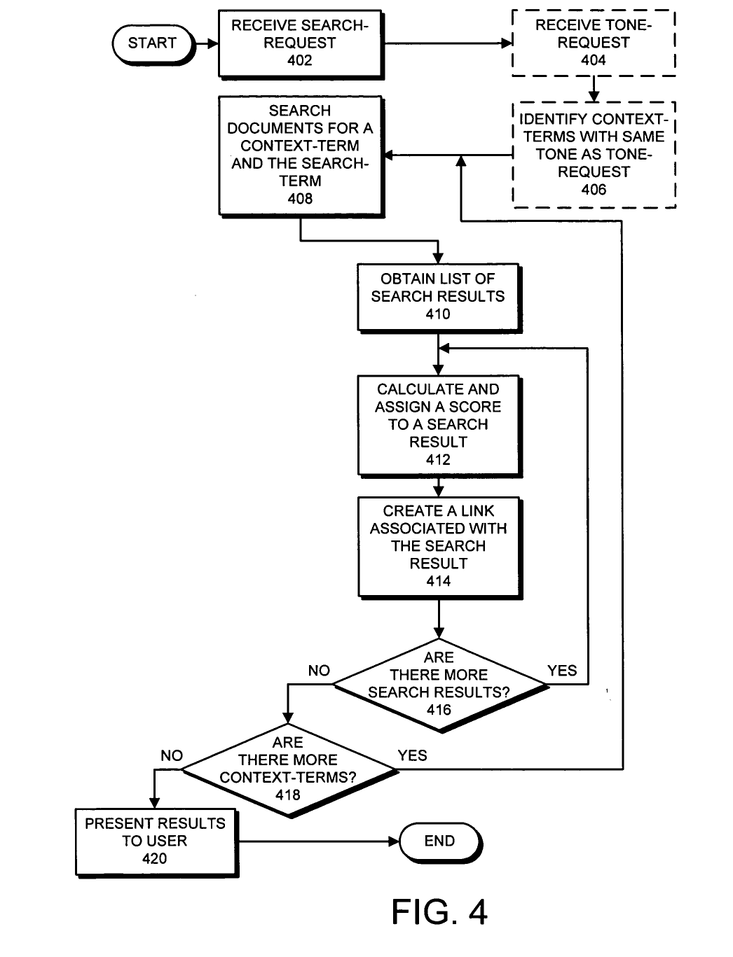

FIG. 4 presents a flowchart illustrating the process of performing a search in accordance with an embodiment of the present invention.

The process begins when search engine 190 receives a search-request, which includes a search-term, from user 112 (step 402).

In one embodiment of the present invention, search engine 190 receives a tone-request from user 112 (step 404). In response to the tone-request, search engine 190 identifies context-terms of the same tone as the tone-request (step 406). These steps are optional as illustrated by the dashed lines surrounding steps 404 and 406.

In one embodiment of the present invention, the tone can be a positive tone, a negative tone, or a neutral tone.

Next, search engine 190 searches network 140 for documents that include both the search-term and a context-term from a pre-defined list of context-terms (step 408). Note that the pre-defined list of context-terms can include user-defined context-terms, system-defined context-terms, or a combination thereof.

In one embodiment of the present invention, search engine 190 searches one or more of network 140, database 130, server 150, server 160, server 170, client 110, laptop 120, and the Internet for documents that include both the search-term and a context-term from a pre-defined list of context-terms. In this embodiment, the documents are not limited to web-pages, but can include any type of electronic document including both local documents, and remote documents. Furthermore, a document can be defined as any quantifiable data. This can include: a single word; words in any language or encoding, such as Japanese, French, or Pig-Latin; an encrypted word; an acronym; a word represented with ANSI (American National Standards Institute) characters; a word represented by Unicode characters; or any other method of representing data known to those familiar with the art.

In one embodiment of the present invention, search engine 190 searches network 140 for documents that include both the search-term and a context-term with the same tone as the tone-request from a pre-defined list of context-terms.

After searching network 140, search engine 190 obtains a list of search results (step 410). Search engine 190 can then calculate and assigns a score to the first search result on the list of search results (step 412). Note that search engine 190 can use a system-defined, or user-defined formula to calculate the score for the search result. The score can be based on one or more of: a tone associated with a context-word included with the search result; a strength of the tone associated with a context-word included with the search result; the number of context-words included with the search result; a frequency of a context-word included with the search result; a relative location of each context-term with respect to the search-term included with the search result; a relative location of each context-term with respect to other context-terms included with the search result; or any other method of basing the score known to those familiar with the art.

Next, search engine 190 creates a link associated with the search result (step 414). Search engine 190 then determines if there are more search results on the list of search results (step 416). If so, search engine 190 repeats step 412 with the next search result from the list of search results.

If there are no more search results on the list, search engine 190 then determines if there are more context-terms on the pre-defined list of context-terms (step 418). If so, search engine 190 repeats step 408 with the next context-term from the pre-defined list of context-terms.

On the other hand, if there are no more context-terms on the pre-defined list of context-terms, search engine 190 presents the search results to user 112 (step 420). Note that presenting the search results to user 112 involves search engine 190 presenting the scores and the links associated with the search results to user 112.

In one embodiment of the present invention, a link can include: a pointer to a web-page; a pointer to a remote document; a pointer to a local document; a phone number; an e-mail address; a postal address; or any other method of finding a document known to those familiar with the art. In this embodiment, a document can include any quantifiable set of data including information that can lead to user 112 obtaining the data, such as the contact information of a second user, or an organization. Furthermore, a link is not limited to pointing to documents that include the search-terms and context-terms, but can link to documents that facilitate in obtaining the information associated with the search-terms and context-terms.

### Retrieving a Document

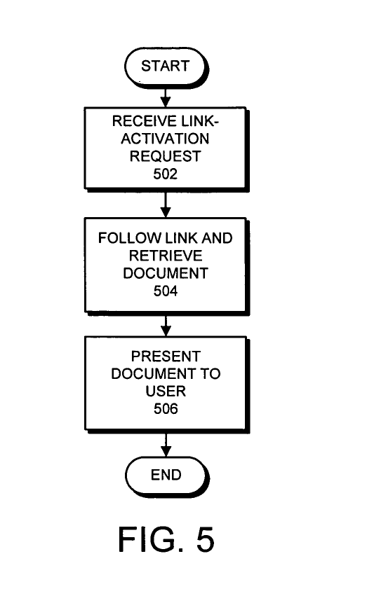

FIG. 5 presents a flowchart illustrating the process of presenting a document to a user in accordance with an embodiment of the present invention.

The process begins when search engine 190 receives a link activation request that specifies a link to activate from user 112 (step 502). In response to the link activation request, search engine 190 retrieves the document associated with the link from the location associated with the link (step 504). In this embodiment, the location associated with the link can be on a local system, or a remote system. Note that a remote system can include a system located on the Internet, or database 130. The process completes when search engine 190 presents the document associated with the link to user 112 (step 506).

In one embodiment of the present invention, presenting the document to user 112 involves presenting the portion of the document associated with the link that includes the search-term and the context-term(s).

In one embodiment of the present invention, presenting the document to user 112 involves ensuring that the portion of the document associated with the link that includes the search-term and the context-term(s) is present in client 110's viewing area.

### Preprocessing Documents

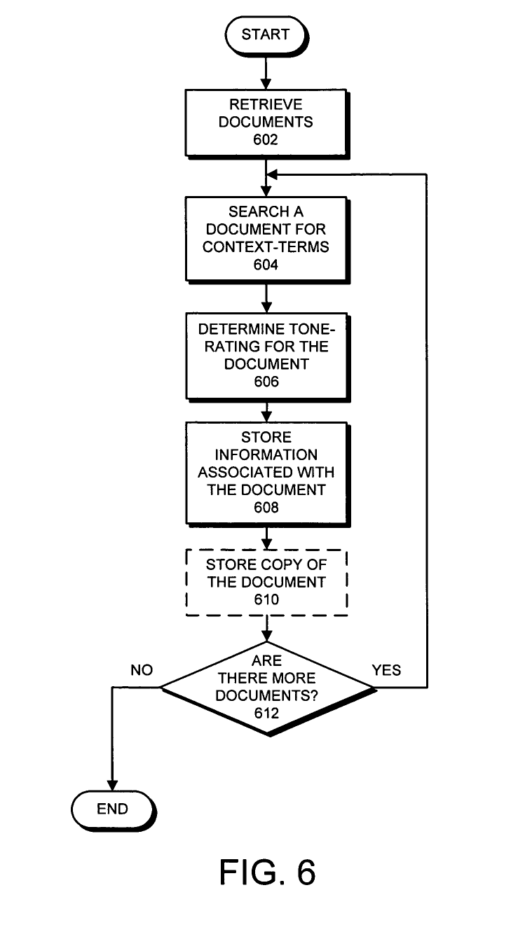

FIG. 6 presents a flowchart illustrating the process of preprocessing documents in accordance with an embodiment of the present invention.

The process begins when web crawler 180 retrieves a set of documents from a local system or a remote system (step 602). Next, web crawler 180 searches a document from the set of documents for context-terms from the list of pre-defined context-terms (step 604). Using the result of the search for context-terms, web crawler 180 determines a tone-rating for the document (step 606).

In one embodiment of the present invention, the tone-rating can be based on one or more of: a tone associated with each context-word found in the document; a frequency of each context-word found in the document; a relative location of each context-word found in the document with respect to other context-words found in the document; or any other method for determining a tone-rating known to those familiar with the art.

Next, web crawler 180 stores information associated with the document, such as the document's tone rating, in database 130 (step 608). This information facilitates search engine 190 to fulfill a search-request from user 112.

In one embodiment of the present invention, web crawler 180 stores a copy of the document on database 130 to facilitate search engine 190 to identify and retrieve the document (step 610). This step is optional as indicated by the dashed lines surrounding step 610.

Next, web crawler 180 determines if there are any more documents to search for context-terms (step 612). If so, web crawler 180 returns to step 604.

### Identifying Documents to Search

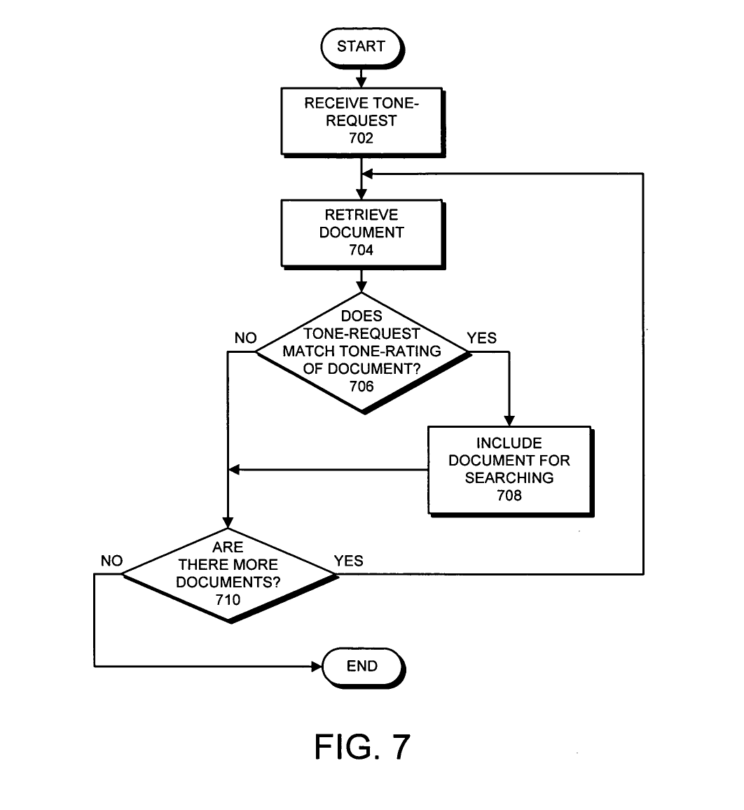

FIG. 7 presents a flowchart illustrating the process of identifying documents to search in accordance with an embodiment of the present invention.

The process begins when search engine 190 receives a tone-request from user 112 (step 702). In response to the tone-request, search engine 190 retrieves a document from database 130 (step 704).

In one embodiment of the present invention, search engine 190 retrieves a document from network 140, server 150, server 160, server 170, client 110, laptop 120, or the Internet.

Next, search engine 190 determines if the tone-rating associated with the document matches the tone associated with the tone-request (step 706). If so, search engine 190 includes the document with a set of documents, which search engine 190 searches in response to a search-request from user 112 (step 708). Note that the search-request is associated with the tone-request. Next, search engine 190 determines if there are more documents stored on database 130 (step 710). If so, search engine 190 returns to step 704.

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for performing a tone-based search, comprising:
receiving a search-request, which includes a search-term;
for each context-term in a pre-defined list of context-terms, searching a first set of documents for the context-term and the search-term, wherein each context-term is associated with a tone;
obtaining a list of search results from the search; and
for each search result in the list of search results:
assigning a score to the search result, and
creating a link which points to the location in a document of an occurrence of the search-term and an occurrence of a context-term.

2. The method of claim 1, wherein the tone can be a positive tone, a negative tone, or a neutral tone.

3. The method of claim 1, wherein receiving the search-request involves:
receiving a tone-request, which is a request to search for terms that have a specific tone; and
wherein searching the first set of documents involves searching for context-terms having the specific tone associated with the tone-request.

4. The method of claim 1, further comprising calculating the score for a search result based on at least one of:
a tone associated with each context-term;
a frequency of each context-term;
a relative location of each context-term with respect to the search-term; or
a relative location of each context-term with respect to other context-terms in the pre-defined list of context-terms.

5. The method of claim 1, wherein prior to receiving a search-request, the method further comprises:
for each document in a second set of documents:
searching for a set of context-terms from the pre-defined list of context-terms; and
determining a tone-rating for the document based on context-terms identified in the document, wherein the tone-rating can be positive, negative, or neutral.

6. The method of claim 5, wherein the first set of documents is a subset of the second set of documents.

7. The method of claim 6, further comprising:
receiving a tone-request;
matching the tone-request to the tone-rating of each document in the second set of documents; and
if the tone-request matches the tone-rating of a document in the second set of documents, identifying the document as a member of the first set of documents.

8. The method of claim 1, wherein in response to activating a link for a search result, the method further comprises:
following the link to a document which includes an occurrence of the search-term and an occurrence of the context-term in the document; and
presenting the document to a user.

9. The method of claim 5, wherein the tone-rating can be based on at least one of:
a tone associated with each context-term in the document;
a frequency of each context-term in the document; or
a relative location of each context-term with respect to other context-terms in the document.

10. A computer-readable storage medium storing instructions that when executed by a computer cause the computer to perform a method for performing a tone-based search, the method comprising:
receiving a search-request, which includes a search-term;
for each context-term in a pre-defined list of context-terms, searching a first set of documents for the context-term and the search-term, wherein each context-term is associated with a tone;
obtaining a list of search results from the search; and
for each search result in the list of search results:
assigning a score to the search result, and
creating a link which points to the location in a document of an occurrence of the search-term and an occurrence of a context-term.

11. The computer-readable storage medium of claim 10, wherein the tone can be a positive tone, a negative tone, or a neutral tone.

12. The computer-readable storage medium of claim 10, wherein receiving the search-request involves:
receiving a tone-request, which is a request to search for terms that have a specific tone; and
wherein searching the first set of documents involves searching for context-terms having the specific tone associated with the tone-request.

13. The computer-readable storage medium of claim 10, the method further comprising calculating the score for a search result based on at least one of:
a tone associated with each context-term;
a frequency of each context-term;
a relative location of each context-term with respect to the search-term; or
a relative location of each context-term with respect to other context-terms in the pre-defined list of context-terms.

14. The computer-readable storage medium of claim 10, wherein prior to receiving a search-request, the method further comprises:
for each document in a second set of documents:
searching for a set of context-terms from the pre-defined list of context-terms; and
determining a tone-rating for the document based on context-terms identified in the document, wherein the tone-rating can be positive, negative, or neutral.

15. The computer-readable storage medium of claim 14, wherein the first set of documents is a subset of the second set of documents.

16. The computer-readable storage medium of claim 15, the method further comprising:
receiving a tone-request;
matching the tone-request to the tone-rating of each document in the second set of documents; and
if the tone-request matches the tone-rating of a document in the second set of documents, identifying the document as a member of the first set of documents.

17. The computer-readable storage medium of claim 10, wherein in response to activating a link for a search result, the method further comprises:
following the link to a document which includes an occurrence of the search-term and an occurrence of the context-term in the document; and
presenting the document to a user.

18. The computer-readable storage medium of claim 14, wherein the tone-rating can be based on at least one of:
a tone associated with each context-term in the document;
a frequency of each context-term in the document; or
a relative location of each context-term with respect to other context-terms in the document.

19. An apparatus that performs a tone-based search, comprising:
a receiving mechanism configured to receive a search-request, which includes a search-term;
a first searching mechanism configured to search a first set of documents for a context-term and the search-term, wherein each context-term is associated with a tone, and wherein each context-term is a member of a pre-defined list of context-terms;
an obtaining mechanism configured to obtain a list of search results from the search;
an assigning mechanism configured to assign a score to each search result in the list of search results; and
a creating mechanism configured to create a link which points to the location in a document of an occurrence of the search-term and an occurrence of a context-term for each search result in the list of search results.

20. The apparatus of claim 19, wherein the receiving mechanism is further configured to receive a tone-request, which is a request to search for terms that have a specific tone, and wherein the searching mechanism is further configured to search the first set of documents for context-terms having the specific tone associated with the tone-request.

21. The apparatus of claim 19, further comprising a calculating mechanism configured to calculate the score for a search result based on at least one of:
a tone associated with each context-term;
a frequency of each context-term;
a relative location of each context-term with respect to the search-term; or
a relative location of each context-term with respect to other context-terms in the pre-defined list of context-terms.

22. The apparatus of claim 19, further comprising:
a second searching mechanism configured to search each document in a second set of documents for a set of context-terms from the pre-defined list of context-terms; and
a determining mechanism configured to determine a tone-rating for each document in a set of documents based on context-terms identified in the document, wherein the tone-rating can be positive, negative, or neutral.

23. The apparatus of claim 22, wherein the receiving mechanism is configured to receive a tone-request, the apparatus further comprising:
a matching mechanism configured to match the tone-request to the tone-rating of each document in the second set of documents; and
an identifying mechanism configured to identify a document as a member of the first set of documents, if the tone-request matches the tone-rating of the document.

24. The apparatus of claim 19, further comprising an activation mechanism configured to activate a link for a search result by:
following the link to a document which includes an occurrence of the search-term and an occurrence of the context-term in the document; and
presenting the document to a user.
